(19) United States
(12) Patent Application Publication
(10) Pub. No.: US 2005/0278382 A1
(43) Pub. Date: Dec. 15, 2005

(54) Method and apparatus for recovery of a current read-write unit of a file system

(75) Inventors: Michael J. LaRocca, Valencia, PA (US); Narayana Tummala, Gibsonia, PA (US); William L. Snider, Sewickley, PA (US)

Correspondence Address: Ansel M. Schwartz, Suite 304, 201 N. Craig Street, Pittsburgh, PA, 15213, US

(73) Assignee: Network Appliance, Inc.

(21) Appl. No.: 10/856,448

(22) Filed: May 28, 2004

(51) Int. Cl. G06F 7/00

(52) U.S. Cl. 707/200

(57) ABSTRACT

An apparatus for recovering a current read-write Virtual File System (VFS) includes a network element which receives client requests and makes calls responding to the client requests. The apparatus includes a VFS location database which maintains information about VFSes. The apparatus includes a disk element in which VFSes are disposed and which, when effective access to the current read-write VFS is lost, the disk element promotes a read-only VFS of the current read-write VFS to a read-write VFS. A method for recovering a current read-write VFS includes the steps of losing effective access to the current read-write VFS. There is the step of promoting a read-only VFS of the current read-write VFS to a read-write VFS.

### FIELD OF THE INVENTION

The present invention is related to the recovery of a current read-write unit of a file system, where the unit is preferably a Virtual File System (VFS), after losing effective access to it. More specifically, the present invention is related to the recovery of a current read-write VFS after losing effective access to it by promoting a read-only VFS of the current read-write VFS to a read-write VFS which is transparent to a client.

### BACKGROUND OF THE INVENTION

A storage system is a computer that provides storage (file) service relating to the organization of information on storage devices, such as disks. The storage system may be deployed within a network attached storage (NAS) environment and, as such, may be embodied as a file server. The file server or filer includes a storage operating system that implements a file system to logically organize the information as a hierarchical structure of directories and files on the disks. Each “on-disk” file may be implemented as a set of data structures, e.g., disk blocks, configured to store information. A directory, on the other hand, may be implemented as a specially formatted file in which information about other files and directories are stored.

Disk storage is typically implemented as one or more storage “volumes” that reside on physical storage disks, defining an overall logical arrangement of storage space. A physical volume, comprised of a pool of disk blocks, may support a number of logical volumes. Each logical volume is associated with its own file system (i.e., a virtual file system) and, for purposes hereof, the terms volume and virtual file system (VFS) shall generally be used synonymously. The disks supporting a physical volume are typically organized as one or more groups of Redundant Array of Independent (or Inexpensive) Disks (RAID).

Filers are deployed within storage systems configured to ensure availability, reliability and integrity of data. In addition to RAID, storage systems often provide data reliability enhancements and disaster recovery techniques, such as clustering failover, snapshot, and mirroring capability. In the first of these techniques, in the event a clustered filer fails or is rendered unavailable to service data access requests to storage elements (e.g., disks) owned by that filer, a cluster partner has the capability of detecting that condition and of taking over those disks to service the access requests in a generally client transparent manner.

A prior approach providing copies of a storage element in case the original becomes unavailable uses conventional mirroring techniques to create mirrored copies of disks often at geographically remote locations. These copies may thereafter be “broken” (split) into separate copies and made visible to clients for different purposes, such as writable data stores. For example, assume a user (system administrator) creates a storage element, such as a database, on a database server and, through the use of conventional asynchronous/synchronous mirroring, creates a “mirror” of the database. By breaking the mirror using conventional techniques, full disk-level copies of the database are formed. A client may thereafter independently write to each copy, such that the content of each “instance” of the database diverges in time.

A noted disadvantage of these prior art approaches to ensuring the continued data availability to clients is when a read-write VFS becomes corrupted or otherwise inaccessible, especially in circumstances where the corruption or inaccessibility is considered a disaster, that is permanent. What is needed is a seamless, transparent recovery from the disaster that affords a client quick, effective access to the corrupted or otherwise inaccessible read-write VFS.

It would be desirable to provide storage system improvements for disaster recovery and data availability continuance, including techniques for recovering a current read-write VFS or other unit of a file system when the original becomes unavailable.

### SUMMARY OF THE INVENTION

The present invention includes a procedure for promoting a read-only VFS to a read-write VFS. This procedure was designed for use with disaster recovery after the read-write VFS becomes corrupted or otherwise inaccessible.

The recovery time is negligible since an online read-only VFS is used for the recovery instead of secondary storage such as tape backup. The recovery is also seamless since clients will transparently be directed to the newly promoted read-write VFS.

The present invention pertains to an apparatus for recovering a current read-write unit of a file system, which preferably is a VFS. The apparatus comprises a network element which receives client requests and makes calls responding to the client requests. The apparatus comprises a VFS location database which maintains information about VFSes. The apparatus comprises a disk element in which VFSes are disposed. The apparatus includes a manager which, when effective access to the current read-write VFS is lost, the manager element promotes a read-only VFS of the current read-write VFS to a read-write VFS.

The present invention pertains to a method for recovering a current read-write unit of a file system, which preferably is a VFS. The method comprises the steps of losing effective access to the current read-write VFS. There is the step of promoting a read-only VFS of the current read-write VFS to a read-write VFS.

### BRIEF DESCRIPTION OF THE DRAWINGS

In the accompanying drawings, the preferred embodiment of the invention and preferred methods of practicing the invention are illustrated in which:

FIG. 1 is a schematic block diagram of a plurality of nodes interconnected as a cluster that may be advantageously used with the present invention.

FIG. 2 is a schematic block diagram of a node that may be advantageously used with the present invention.

FIG. 3 is a schematic block diagram illustrating the storage subsystem that may be advantageously used with the present invention.

FIG. 4 is a schematic block diagram of a storage operating system that may be advantageously used with the present invention.

FIG. 5 is a schematic block diagram of a D-blade that may be advantageously used with the present invention.

FIG. 6 is a schematic block diagram illustrating the format of a SpinFS request that may be advantageously used with the present invention.

FIG. 7 is a schematic block diagram illustrating the format of a file handle that may be advantageously used with the present invention.

FIG. 8 is a schematic block diagram illustrating a collection of management processes that may be advantageously used with the present invention.

FIG. 9 is a schematic block diagram illustrating a distributed file system arrangement for processing a file access request in accordance with the present invention.

FIG. 10 is a diagram showing two filers configured to increase the availability of the file system of the present invention.

FIG. 11 is a table showing a chain in a VLDB.

FIG. 12 is a diagram of a three filer cluster.

FIG. 13 is a table showing the chain in FIG. 11 with a read-only VFS promoted to a read-write VFS in the VLDB.

FIG. 14 is a diagram of a three filer cluster with filer a damaged.

FIG. 15 is a schematic representation of an apparatus of the present invention.

### DETAILED DESCRIPTION

Referring now to the drawings wherein like reference numerals refer to similar or identical parts throughout the several views, and more specifically to FIG. 15 thereof, there is shown an apparatus 10 for recovering a current read-write unit of a file system, which preferably is a VFS. The apparatus 10 comprises a network element which receives client requests and makes calls responding to the client requests. The apparatus 10 comprises a VFS location database 830 which maintains information about VFSes. The apparatus 10 comprises a disk element in which VFSes are disposed. The apparatus 10 includes a manager 27 which, when effective access to the current read-write VFS is lost, the manager 27 promotes a read-only VFS of the current read-write VFS to a read-write VFS. The manager 27 is preferably in communication with the disk element, and the database 830.

Preferably, the manager 27 restores the current read-write VFS within one minute of losing effective access to the current read-write VFS. The apparatus 10 preferably includes a storage pool 350 disposed in the disk element in which content of a VFS is stored. Preferably, the information about a VFS in the VFS location database identifies the VFS by name, ID and storage pool 350 ID.

Preferably, the manager 27 selects a candidate read-only VFS which is to be promoted into the current read-write VFS that has been selected by an administrator 29. Preferably, the manager 27 uses the candidate VFS selected by the administrator 29 from a group of a spinshot or mirror of the current read-write VFS. The disk element preferably includes a D-blade 500. Preferably, the network element includes an N-blade 110.

The present invention pertains to a method for recovering a current read-write unit of a file system, which preferably is a VFS. The method comprises the steps of losing effective access to the current read-write VFS. There is the step of promoting a read-only VFS of the current read-write VFS to a read-write VFS.

Preferably, there is the step of selecting a candidate read-only VFS which is to be promoted into the current read-write VFS. There is preferably the step of modifying meta-data for the candidate read-only VFS enabling client-requests to be serviced by the candidate read-only VFS once the candidate read-only VFS has been promoted to the read-write VFS. Preferably, the selecting step includes the step of selecting by an administrator 29 the candidate read-only VFS which is to be promoted into the current re-write the VFS.

The selecting step preferably includes the step of selecting the candidate VFS from a group of a spinshot or mirror of the current read-write VFS. Preferably, there is the step of assigning a VFS ID of the current read-write VFS to the candidate read-only VFS. There is preferably the step of deleting the current read-write VFS. Preferably, the deleting step includes the step of deleting any record of the current read-write VFS from the VLDB 830.

There is preferably the step of setting the candidate read-only VFS's identity to the current read-write VFS's identity in the VLDB 830 and on a D-blade 500. Preferably, the setting step includes the step of changing the candidate read-only VFS's name to the current read-write VFS's name. The setting step preferably includes the step of changing the candidate read-only VFS type to read-write. Preferably, there is the step of forming a mirror chain from spinshots of the current read-write VFS.

The candidate read-only VFS has a data version, and there is preferably the step of swapping with the candidate read-only VFS a VFS ID of a spinshot in the chain with a data version that is less than or equal to the data version of the candidate read-only VFS for a mirror whose data version is greater than the data version of the candidate read-only VFS. Preferably, there is the step of deleting a VLDP record of a mirror spinshot selected for swapping its VFS ID that is inaccessible. There is preferably the step of deleting a mirror from the D-blade 500 and setting the mirror data version in the VLDB 830 if no mirror spinshot of the chain is found for swapping its VFS ID to insure a full copy is performed for a next mirror of the current read-write VFS.

Preferably, there is the step of copying the current read-write VFS content to a storage pool 350 when the current read-write VFS is initially mirrored. There is preferably the step of copying an incremental change, represented by a delta between the data versions of the current read-write VFS and the initial mirror, to a subsequent mirror of the current read-write VFS when the subsequent mirror is performed. Preferably, the promoting step includes the step of restoring the current read-write VFS within one minute of losing effective access to the current read-write VFS. The promoting step is preferably transparent to a client. Preferably, there is the step of preserving the current read-write VFS family relationship to eliminate any possibility of corrupting data on a subsequent operation.

In the operation of the described embodiment of the invention, the following terms are applicable.

Virtual File System (VFS): A logical container implementing a file system, such as the Spinnaker File System (SpinFS). A VFS is managed as a single unit; the entire VFS can be mounted, moved, copied or mirrored. Each VFS has a data version which is incremented for each VFS modification. A VFS, in the broadest sense, is representative of a unit of a file system to which management operations are applied.

Mirror VFS: A point in time read-only copy of a read-write VFS. Mirrors can be located on the same or different storage pool 350 as the read-write VFS.

Spinshot VFS: A point in time read-only copy of a read-write VFS. Spinshots are located on the same storage pool 350 as the VFS which they are copies of. It should be noted that “Spinshot” and “Snapshot” are trademarks of Network Appliance, Inc. and is used for purposes of this patent to designate a persistent consistency point (CP) image. A persistent consistency point image (PCPI) is a space conservative, point-in-time read-only image of data accessible by name that provides a consistent image of that data (such as a storage system) at some previous time. More particularly, a PCPI or clone is a point-in-time representation of a storage element, such as a file, database, or an active file system (i.e., the image of the file system with respect to which READ and WRITE commands are executed), stored on a storage device (e.g., on disk) or other persistent memory and having a name or other identifier that distinguishes it from other PCPIs taken at other points in time. A PCPI can also include other information (metadata) about the active file system at the particular point in time for which the image is taken. The terms “PCPI”, “snapshot” and “spinshot” may be used interchangeably throughout this patent without derogation of Network Appliance's trademark rights.

VFS chain: A series one or more VFSes related by blocks of data which they share. There is one head VFS per chain. The head VFS always has the highest data version. Each downstream VFS has a data version equal to or less than its upstream VFS.

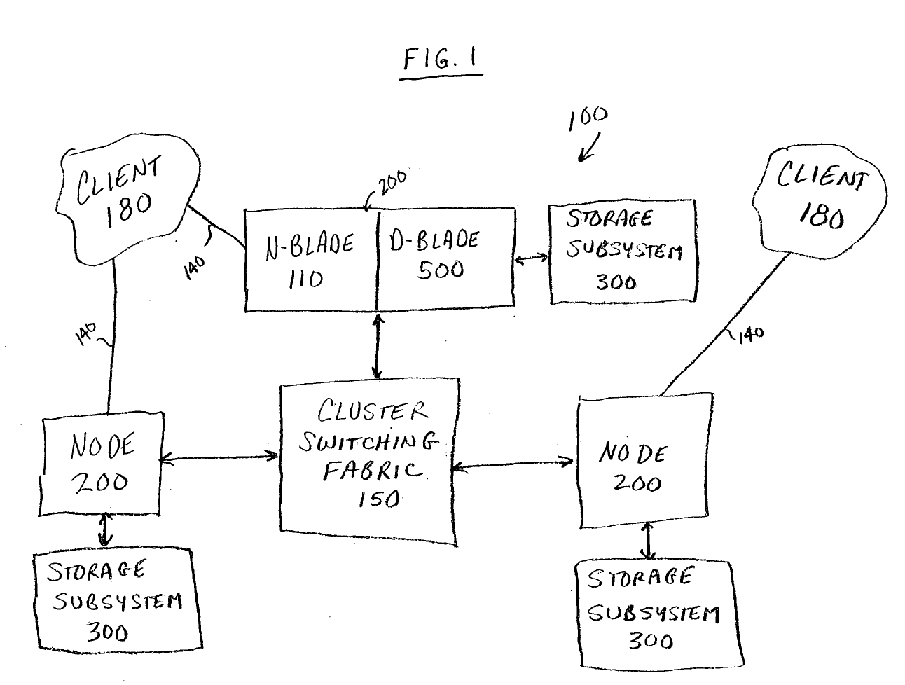

VFS family: A family is comprised of one read-write chain and zero or more mirror chains. The read-write chain has a read-write head. The mirror chain has a mirror head. See FIG. 1.

VFS Location Database (VLDB) 830: A database which keeps track of each VFS in the cluster. For every VLDB 830 record there is a corresponding physical VFS located on a filer in the cluster. Each VFS record in the VLDB 830 identifies the VFS by name, ID and Storage pool 350 ID. Each of these IDs is cluster wide unique. The VLDB 830 is updated by system management software when a VFS is created or deleted. The N-blade 110 is a client of the VLDB 830 server. The N-blade 110 makes RPC calls to resolve the location of a VFS when responding to client requests.

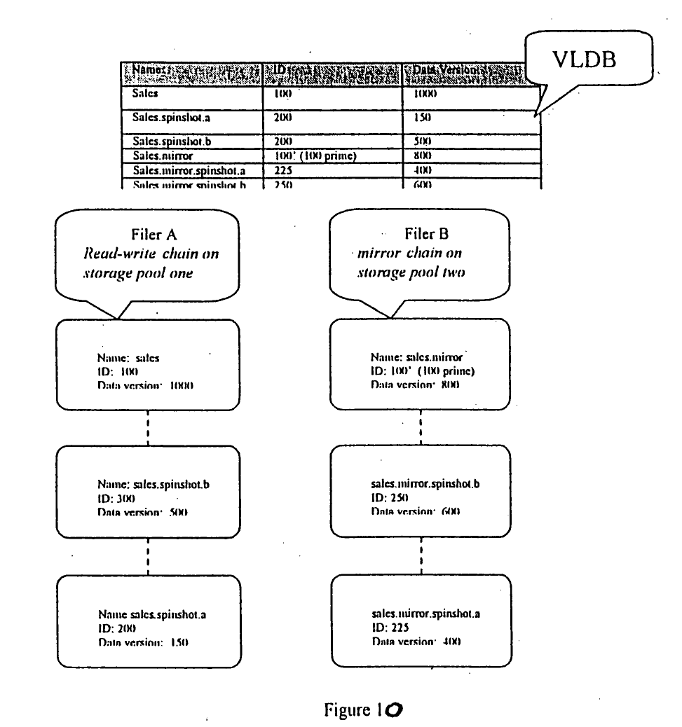

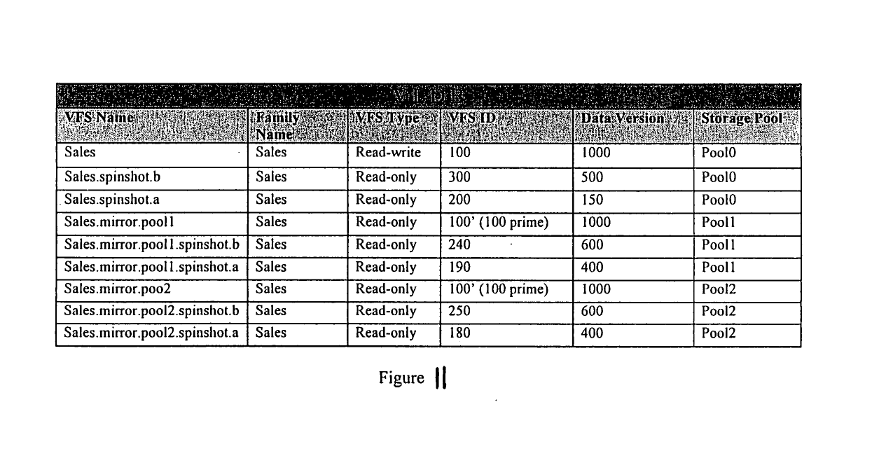

The following example deployment makes use of mirrors for a backup solution instead of secondary storage such as tape backup. Two filers are configured to form a cluster of two. Additional filers can be used to further increase the availability of the file system. See FIG. 10.

The cluster presents a global file system name space. Storage for the name space can reside on either or both of the filers and may be accessed from both filers using the same path (e.g. /usr/larry). A filer in the broadest sense is representative of a node. A node comprises an N-blade and D-blade, which form a pair, a network interface and storage. A cluster of one simply has a single node or filer. The technique described herein is applicable to a single node.

In an example deployment, a read-write VFS named “sales” is created on filer-A. Over time, a spinshot of the sales VFS is periodically made. Scheduled spinshots occur on the sales VFS forming a chain. See FIG. 10. A mirror of the sales VFS is created on filer-B. Each filer will be configured to house a mirror of each read-write VFS located on the other filer.

The recovery of a damaged read-write VFS involves selecting a candidate read-only VFS which will be transformed into the read-write VFS. The candidate can be one of the VFS' mirrors, a spinshot of a mirror, or a spinshot of the damaged VFS. The selection is done by the administrator 29. Once selected the system management software modifies the meta-data for the candidate VFS enabling client requests to be serviced by the newly promoted candidate.

In regard to the promote procedure, a mirror or spinshot is promoted to the head of the family. The spinshot can be of a mirror or the read-write VFS.

In a VFS family, in the example deployment, it is guaranteed that:
1. There is only one read-write VFS.
2. There is only one head per chain.
3. The head is always sitting at the top of the VFS chain.
4. None of the members can be at a higher data version than the head.

When promoting a member, these rules cannot be violated. Otherwise, it might lead into corrupting data on the disk.

In general, VFS IDs are cluster wide unique. In particular a VFS ID for each read-write and spinshot VFS is unique. Each mirror in the family shares the same VFS ID. A new mirror VFS ID is not allocated when a mirror is created as is done with the creation of a read-write and spinshot VFS. Instead, it is derived from the read-write VFS. Conversely, the read-write VFS ID can be derived from its mirror VFS ID. This relationship is used in the promote procedure in the case where the read-write VFS has been deleted from the VLDB 830.

The current read-write VFS (damaged or inaccessible) is referred to as the current read-write VFS. Whether the current read-write VFS is physically present in the VLDB 830 and D-blade 500, it is referred as the current read-write head until the promote process is complete.

The first step in promoting a VFS is to select a read-only VFS within the family which is referred to as the candidate VFS. The selection process is preferably manual although a semi-automatic process can occur where a series of candidates are provided to the administrator. A fully automatic mode can occur where a priority scheme is invoked to choose from the series of candidates. The candidate VFS will become the current read-write VFS when the promote procedure is complete. The candidate VFS can be a spinshot or mirror of the current read-write VFS or a spinshot of a mirror of the current read-write VFS (i.e. any read-only VFS in the family).

1. Determine the Promote Candidate's New VFS ID.

If a VLDB 830 record is present for the current read-write VFS then the candidate will be assigned the VFS ID of the current read-write VFS. If there is not a VLDB 830 record for the current read-write VFS a check is made to determine if there is a mirror in the family. If so the VFS ID of the current read-write VFS is numerically derived from the mirror VFS ID and assigned to the candidate VFS. If there is not a mirror in the family then the candidate must be a spinshot and its ID will be assigned to the candidate VFS.

2. Delete the Current Read-Write VFS.

This is done to enforce family rule #1.

If a VLDB 830 record exists for current read-write VFS then delete it and delete the VFS from the D-blade 500, else skip this step.

If the current read-write VFS can not be deleted from the D-blade 500, then it is deemed inaccessible. Its VLDB 830 record is still deleted which will permanently hide the VFS from the N-blade 110 (files will not be served from it). Deeming the current read-write VFS inaccessible also places it in the lost and found database should the VFS become accessible again.

3. Rollback All Mirrors

NOTE: This step is critical for Rule #4 of the VFS family. Also enables step #5 to complete as quickly as is possible. When a VFS is initially mirrored its complete content is copied to the remote storage pool 350. When subsequent mirrors are performed an incremental copy is done. The changes represented by the delta between the data versions of read-write and mirror VFS are copied to the mirror.

The candidate VFS has a data version referred to as the CANDIDATE-DV.

For each mirror whose data version is greater than the CANDIDATE-DV, find a spinshot in the mirror chain with a data version that is less than or equal to CANDIDATE-DV and swap its VFS ID with the candidate.

If the mirror spinshot selected for the VFS ID swap is deemed to be inaccessible, delete its VLDB 830 record and continue searching the current mirror chain for mirror spinshot with a data version that is less than or equal to CANDIDATE-DV.

If a suitable mirror spinshot is not found then delete mirror from the D-blade 500 and set the data version in its VLDB 830 record to zero. This insures that a full copy is done for the next mirror of the read-write VFS.

Proceed to the next mirror chain in the family.

Delete all family members with a data version greater than the promote candidate.

4. Change the Identity of the Candidate VFS

The identity of the candidate is set to that of the read-write VFS in the VLDB 830 and on the D-blade 500.
Change the VFS ID to the VFS ID from step #1.
Change the VFS name to the name of the read-write VFS.
Change the VFS type to read-write.
   5. Mirror the New Read-Write VFS

If the former read-write VFS had one or more mirrors then perform a mirror operation to insure the mirrors are at a same data version with the newly promoted read-write VFS.

An example of the promote is as follows.

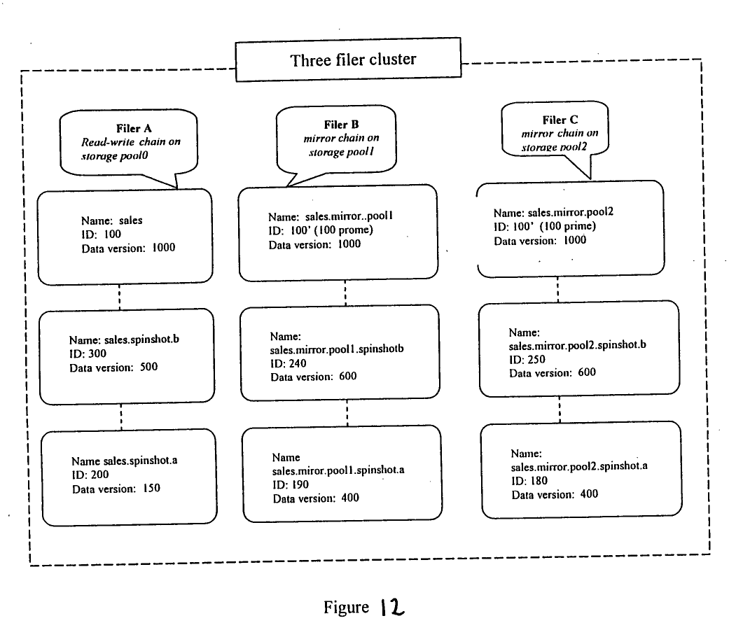

VFS sales becomes inaccessible due to a disaster involving Filer-A. The administrator 29 decides to promote VFS sales.mirror.pool1 which is a mirror of VFS sales. VFS sales and VFS sales.mirror.pool1 are at the same data version (1000). See FIGS. 11 and 12.

The administrator 29 executes the following system management (mgmt) command on Filer-B ‘tools filestorage vfs>promote-vfsname sales.mirror.pool1’.

The following steps detail a specific example of the general descriptions found in section 4.

1. Determine the Promote Candidate's New VFS ID.

The candidate is a mirror. Therefore the VFS ID of the mirror's read-write counter part can be numerically derived from its own VFS ID yielding 100 (100′ yields 100).

2. Delete the Current Read-Write VFS.

The mgmt implementation on Filer-B sends a lookup request to the VLDB 830 for VFS sales.mirror.pool1. The VLDB 830 responds with a record for VFS sales.mirror.pool1. Mgmt extracts the family name ‘sales’ from the record and sends a family-lookup RPC to the VLDB 830. The VLDB 830 responds with a list of the ‘sales’ family member records. Mgmt saves the records in memory for used in this step and the remaining steps in the promote procedure.

Locate VFS: Mgmt needs to determine the IP address of the filer that owns VFS sales. This is done by mapping the storage pool 350 ID to a D-blade 500 ID and then to an IP address. Mgmt first sends a D-blade 500 ID lookup RPC to the VLDB 830 using pool1 as the input argument from the sales record. The VLDB 830 responds with the D-blade 500 ID for pool1. Mgmt then does an in memory lookup for the IP address of the Filer with the D-blade 500 ID obtained in the previous step. This yields the IP address the D-blade 500 in Filer-A.

Mgmt attempts to delete VFS sales on Filer-A but is unable to establish a connection to Filer-A. Mgmt correctly assumes that VFS sales can not be deleted since Filer-A is damaged. Mgmt then sends an RPC to the VLDB 830 to delete the sales record. The VLDB 830 successfully deletes the sales.

3. Rollback All Mirrors.

An attempt to roll back the mirrors is made when the candidate is not the head of a mirror chain. Since sales.mirror.pool1 is the head of the mirror chain roll back is not needed (because there is not a VFS with data version greater than 1000).

4. Delete All Family Members With a Data Version Greater Than the Promote Candidate.

Mgmt searches the list of in memory VLDB 830 records for a VFS with a data version greater than 1000 (the data version of the candidate sales.mirror.pool1). No records meet the search criteria, and therefore, no other VFS in the family must be deleted.

5. Change the Identity of the Candidate VFS.

Mgmt does a lookup for the IP address of the Filer which owns the storage pool2 using the Locate VFS procedure outlined in step #2. This yields the IP address of Filer-B's D-blade 500.

Values needed for the following two RPCs are taken or derived from the sales.mirror.pool1 VLDB 830 record. In both cases the VFS ID and storage pool 350 ID of VFS sales.mirror.pool1 are used to identify the VFS to modify.

Set the on-disk attributes by making an RPC to Filer-B's D-blade 500 using the following arguments:
VFS ID 100 (the ID calculated in step #1)
VFS NAME sales (use the family name contained in the sales.mirror.pool1 VLDB 830 record)
VFS access read-write

Set the VLDB 830 attributes by making an RPC to VLDB 830 server using the following arguments:
VFS ID 100 (the ID calculated in step #1)
VFS NAME sales (taken from the family name contained in the sales.mirror.pool1 VLDB 830 record)
VFS access read-write
   6. Mirror the New Read-Write VFS.

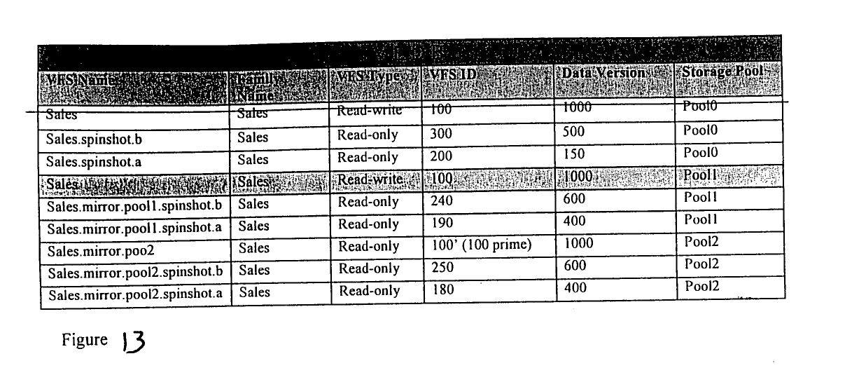

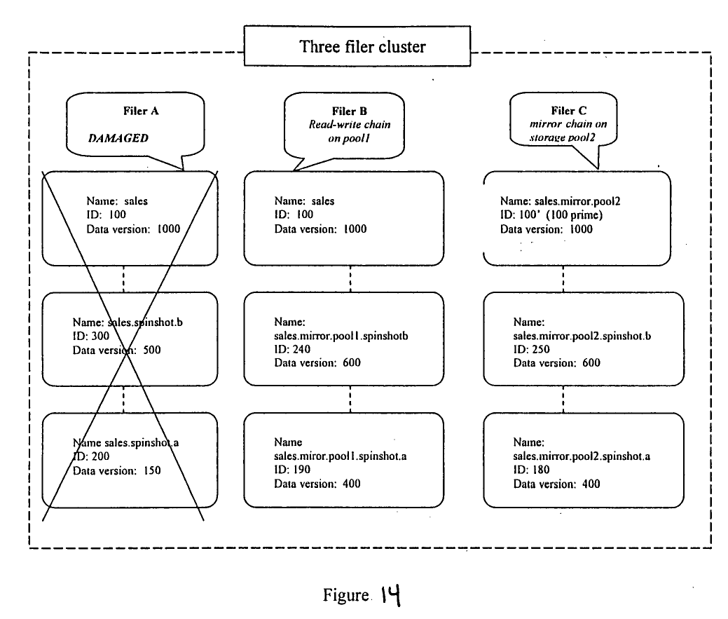

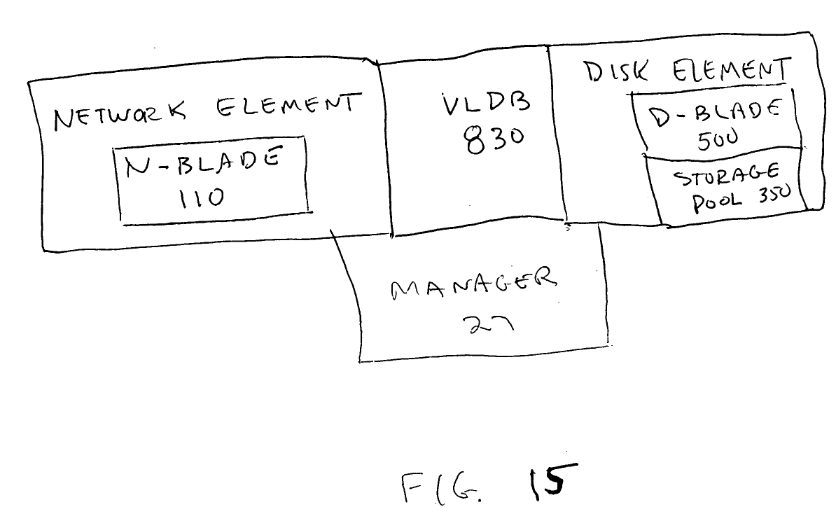

At this point VFS sales.mirror.pool1 has assumed the identity of the former damaged sales VFS. The new sales VFS is now online and responsive to client requests. See FIGS. 13 and 14.

FIG. 1 is a schematic block diagram of a plurality of nodes 200 interconnected as a cluster 100 and configured to provide storage service relating to the organization of information on storage devices of a storage subsystem. The nodes 200 comprise various functional components that cooperate to provide a distributed Spin File System (SpinFS) architecture of the cluster 100. To that end, each SpinFS node 200 is generally organized as a network element (N-blade 110) and a disk element (D-blade 500). The N-blade 110 includes a plurality of ports that couple the node 200 to clients 180 over a computer network 140, while each D-blade 500 includes a plurality of ports that connect the node to a storage subsystem 300. The nodes 200 are interconnected by a cluster switching fabric 150 which, in the illustrative embodiment, may be embodied as a Gigabit Ethernet switch. The distributed SpinFS architecture is generally described in U.S. patent application Publication No. US 2002/0116593 titled “Method and System for Responding to File System Requests”, by M. Kazar et al. published Aug. 22, 2002, incorporated by reference herein.

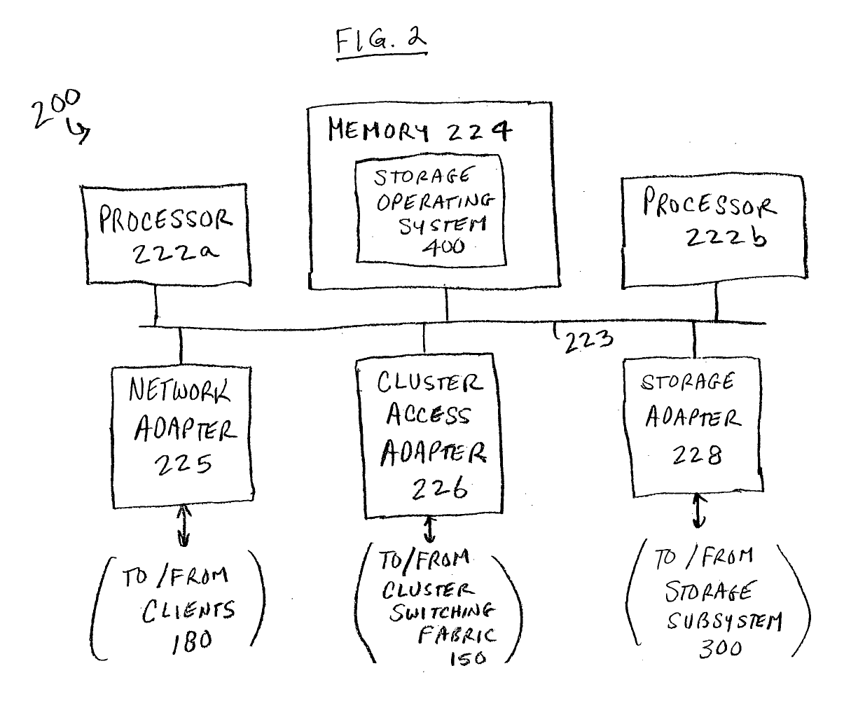

FIG. 2 is a schematic block diagram of a node 200 that is illustratively embodied as a storage system server comprising a plurality of processors 222, a memory 224, a network adapter 225, a cluster access adapter 226 and a storage adapter 228 interconnected by a system bus 223. The cluster access adapter 226 comprises a plurality of ports adapted to couple the node 200 to other nodes of the cluster 100. In the illustrative embodiment, Ethernet is used as the clustering protocol and interconnect media, although it will be apparent to those skilled in the art that other types of protocols and interconnects may be utilized within the cluster architecture described herein.

Each node 200 is illustratively embodied as a dual processor server system executing a storage operating system 300 that provides a file system configured to logically organize the information as a hierarchical structure of named directories and files on storage subsystem 300. However, it will be apparent to those of ordinary skill in the art that the node 200 may alternatively comprise a single or more than two processor system. Illustratively, one processor 222a executes the functions of the N-blade 110 on the node, while the other processor 222b executes the functions of the D-blade 500.

In the illustrative embodiment, the memory 224 comprises storage locations that are addressable by the processors and adapters for storing software program code and data structures associated with the present invention. The processor and adapters may, in turn, comprise processing elements and/or logic circuitry configured to execute the software code and manipulate the data structures. The storage operating system 300, portions of which are typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the inventive system and method described herein.

The network adapter 225 comprises a plurality of ports adapted to couple the node 200 to one or more clients 180 over point-to-point links, wide area networks, virtual private networks implemented over a public network (Internet) or a shared local area network, hereinafter referred to as an Ethernet computer network 140. Therefore, the network adapter 225 may comprise a network interface card (NIC) having the mechanical, electrical and signaling circuitry needed to connect the node to the network. For such a network attached storage (NAS) based network environment, the clients are configured to access information stored on the node 200 as files. The clients 180 communicate with each node over network 140 by exchanging discrete frames or packets of data according to predefined protocols, such as the Transmission Control Protocol/Internet Protocol (TCP/IP).

The storage adapter 228 cooperates with the storage operating system 400 executing on the node 200 to access information requested by the clients. The information may be stored on disks or other similar media adapted to store information. The storage adapter comprises a plurality of ports having input/output (I/O) interface circuitry that couples to the disks over an I/O interconnect arrangement, such as a conventional high-performance, Fibre Channel (FC) link topology. The information is retrieved by the storage adapter and, if necessary, processed by the processor 222 (or the adapter 228 itself) prior to being forwarded over the system bus 223 to the network adapter 225 where the information is formatted into packets or messages and returned to the clients.

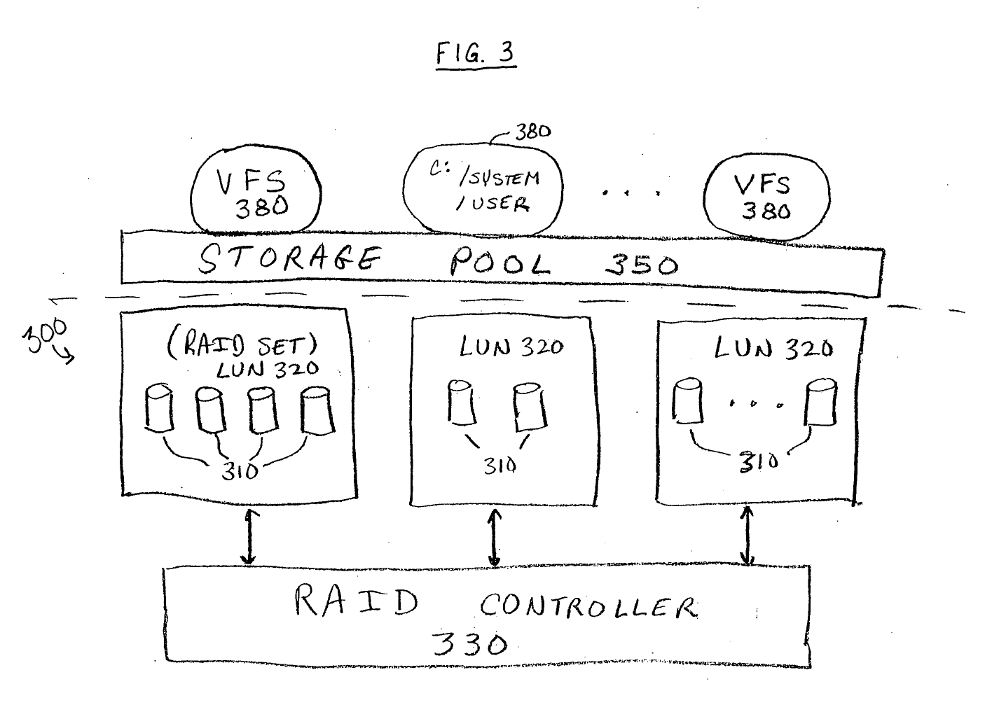

FIG. 3 is a schematic block diagram illustrating the storage subsystem 300 that may be advantageously used with the present invention. Storage of information on the storage subsystem 300 is illustratively implemented as a plurality of storage disks 310 defining an overall logical arrangement of disk space. The disks are further organized as one or more groups or sets of Redundant Array of Independent (or Inexpensive) Disks (RAID). RAID implementations enhance the reliability/integrity of data storage through the writing of data “stripes” across a given number of physical disks in the RAID group, and the appropriate storing of redundant information with respect to the striped data. The redundant information enables recovery of data lost when a storage device fails. It will be apparent to those skilled in the art that other redundancy techniques, such as mirroring, may used in accordance with the present invention.

Each RAID set is configured by one or more RAID controllers 330. The RAID controller 330 exports a RAID set as a logical unit number (LUN 320) to the D-blade 500, which writes and reads blocks to and from the LUN 320. One or more LUNs are illustratively organized as a storage pool 350, wherein each storage pool 350 is “owned” by a D-blade 500 in the cluster 100. Each storage pool 350 is further organized as a plurality of virtual file systems (VFSs 380), each of which is also owned by the D-blade 500. Each VFS 380 may be organized within the storage pool according to a hierarchical policy that, among other things, allows the VFS to be dynamically moved among nodes of the cluster, thereby enabling the storage pool 350 to grow dynamically (on the fly).

In the illustrative embodiment, a VFS 380 is synonymous with a volume and comprises a root directory, as well as a number of subdirectories and files. A group of VFSs may be composed into a larger namespace. For example, a root directory (c:) may be contained within a root VFS (“/”), which is the VFS that begins a translation process from a pathname associated with an incoming request to actual data (file) in a file system, such as the SpinFS file system. The root VFS may contain a directory (“system”) or a mount point (“user”). A mount point is a SpinFS object used to “vector off” to another VFS and which contains the name of that vectored VFS. The file system may comprise one or more VFSs that are “stitched together” by mount point objects.

To facilitate access to the disks 310 and information stored thereon, the storage operating system 400 implements a write-anywhere file system, such as the SpinFS file system, which logically organizes the information as a hierarchical structure of named directories and files on the disks. However, it is expressly contemplated that any appropriate storage operating system, including a write in-place file system, may be enhanced for use in accordance with the inventive principles described herein. Each “on-disk” file may be implemented as set of disk blocks configured to store information, such as data, whereas the directory may be implemented as a specially formatted file in which names and links to other files and directories are stored.

As used herein, the term “storage operating system” generally refers to the computer-executable code operable on a computer that manages data access and may, in the case of a node 200, implement data access semantics of a general purpose operating system. The storage operating system can also be implemented as a microkernel, an application program operating over a general-purpose operating system, such as UNIX® or Windows NT®, or as a general-purpose operating system with configurable functionality, which is configured for storage applications as described herein.

In addition, it will be understood to those skilled in the art that the inventive system and method described herein may apply to any type of special-purpose (e.g., storage serving appliance) or general-purpose computer, including a standalone computer or portion thereof, embodied as or including a storage system. Moreover, the teachings of this invention can be adapted to a variety of storage system architectures including, but not limited to, a network-attached storage environment, a storage area network and disk assembly directly-attached to a client or host computer. The term “storage system” should therefore be taken broadly to include such arrangements in addition to any subsystems configured to perform a storage function and associated with other equipment or systems.

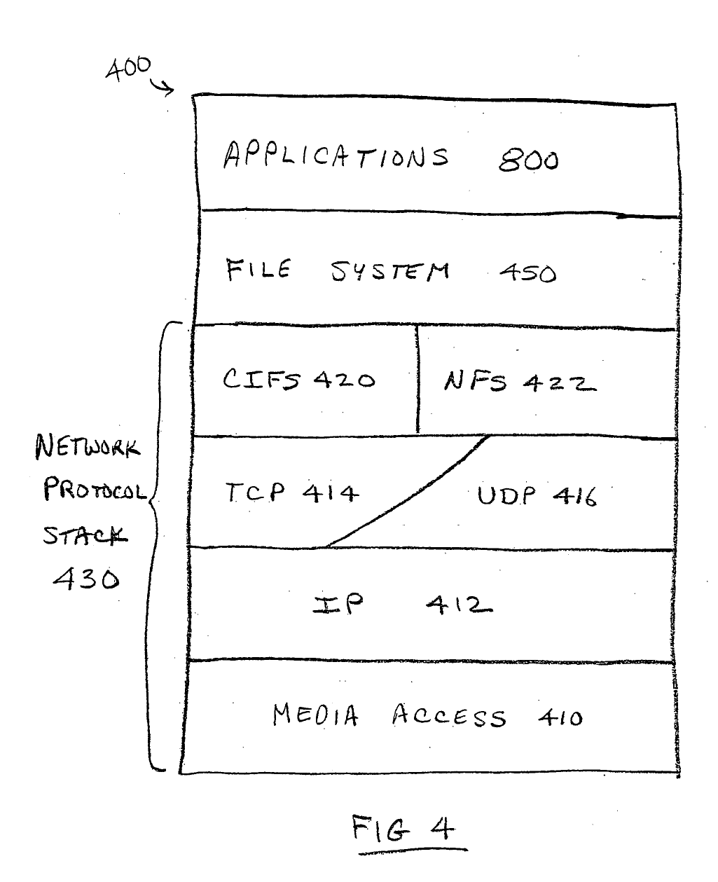

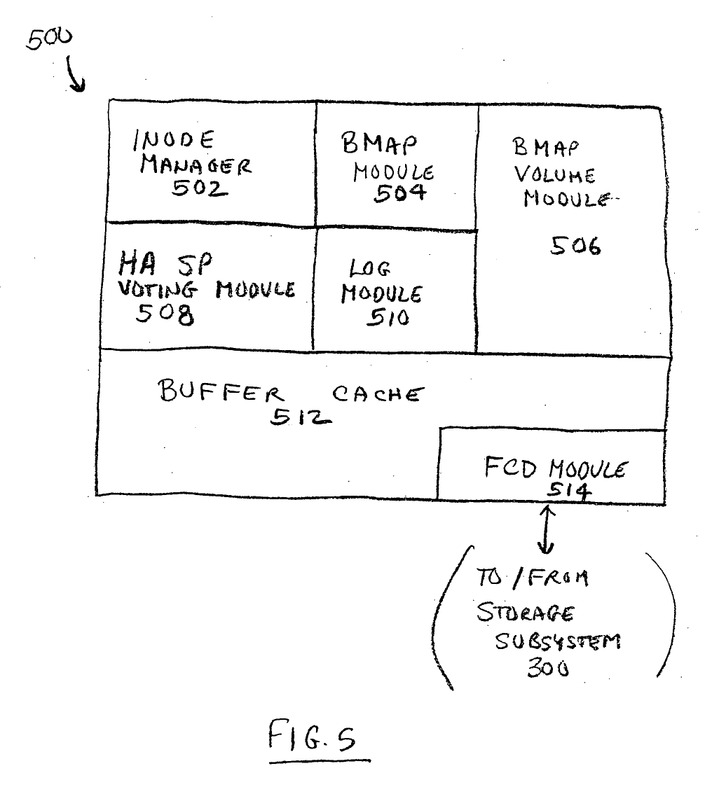

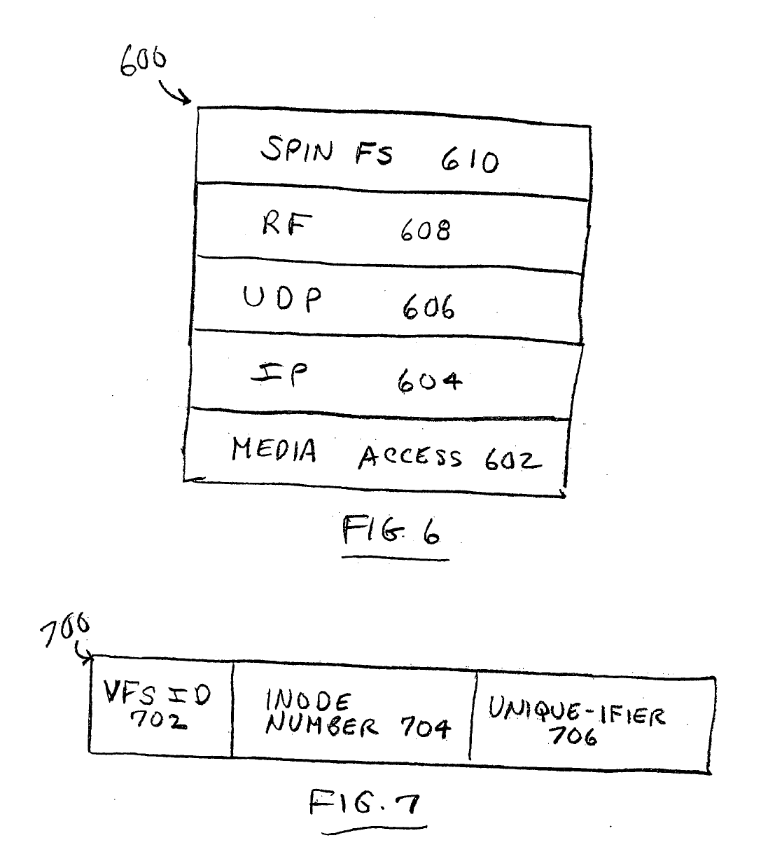

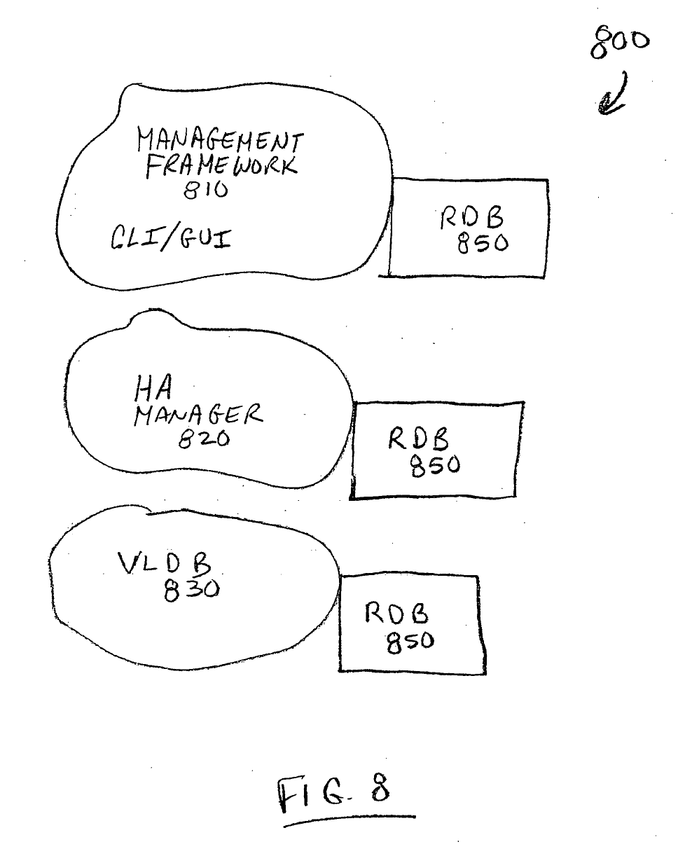

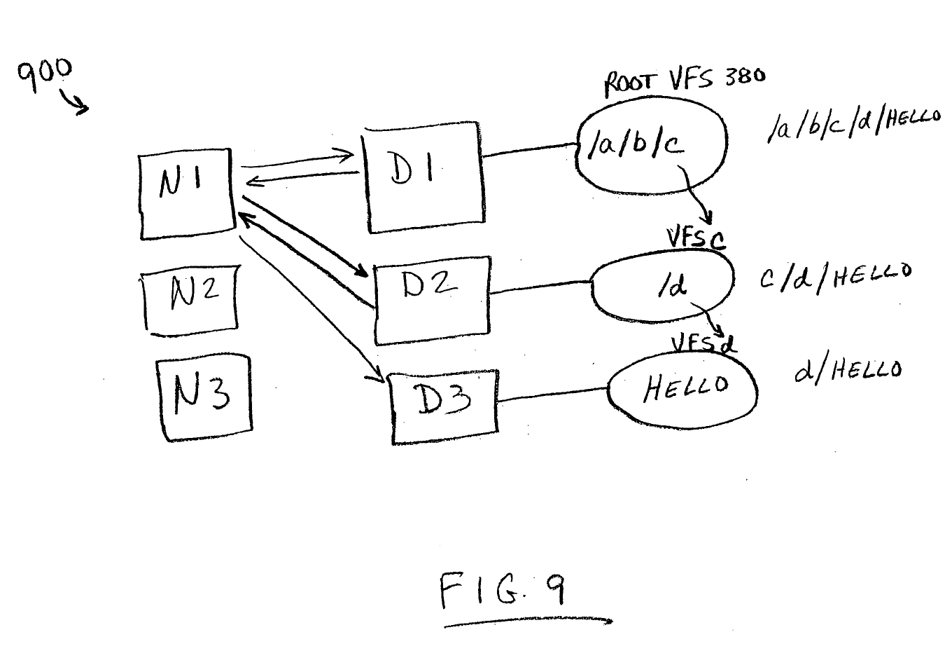

FIG. 4 is a schematic block diagram of the storage operating system 400 that may be advantageously used with the present invention. The storage operating system comprises a series of software layers organized to form an integrated network protocol stack 430 that provides a data path for clients to access information stored on the node 200 using file access protocols. The protocol stack includes a media access layer 410 of network drivers (e.g., gigabit Ethernet drivers) that interfaces to network protocol layers, such as the IP layer 412 and its supporting transport mechanisms, the TCP layer 414 and the User Datagram Protocol (UDP) layer 416. A file system protocol layer provides multi-protocol file access to a file system 450 (the SpinFS file system) and, thus, includes support for the CIFS protocol 220 and the NFS protocol 222. As described further herein, a plurality of management processes executes as user mode applications 800.

In the illustrative embodiment, the processors 222 share various resources of the node 200, including the storage operating system 400. To that end, the N-blade 110 executes the integrated network protocol stack 430 of the operating system 400 to thereby perform protocol termination with respect to a client issuing incoming NFS/CIFS file access request packets over the network 150. The NFS/CIFS layers of the network protocol stack function as NFS/CIFS servers 422, 420 that translate NFS/CIFS requests from a client into SpinFS protocol requests used for communication with the D-blade 500. The SpinFS protocol is a file system protocol that provides operations related to those operations contained within the incoming file access packets. Local communication between an N-blade 110 and D-blade 500 of a node is preferably effected through the use of message passing between the blades, while remote communication between an N-blade 110 and D-blade 500 of different nodes occurs over the cluster switching fabric 150.

Specifically, the NFS and CIFS servers of an N-blade 110 convert the incoming file access requests into SpinFS requests that are processed by the D-blades 500 of the cluster 100. Each D-blade 500 provides a disk interface function through execution of the SpinFS file system 450. In the illustrative cluster 100, the file systems 450 cooperate to provide a single SpinFS file system image across all of the D-blades 500 in the cluster. Thus, any network port of an N-blade 110 that receives a client request can access any file within the single file system image located on any D-blade 500 of the cluster. FIG. 5 is a schematic block diagram of the D-blade 500 comprising a plurality of functional components including a file system processing module (the inode manager 502), a logical-oriented block processing module (the Bmap module 504) and a Bmap volume module 506. Note that inode manager 502 is the processing module that implements the SpinFS file system 450. The D-blade 500 also includes a high availability storage pool (HA SP) voting module 508, a log module 510, a buffer cache 512 and a fiber channel device driver (FCD).

The Bmap module 504 is responsible for all block allocation functions associated with a write anywhere policy of the file system 450, including reading and writing all data to and from the RAID controller 330 of storage subsystem 300. The Bmap volume module 506, on the other hand, implements all VFS operations in the cluster 100, including creating and deleting a VFS, mounting and unmounting a VFS in the cluster, moving a VFS, as well as cloning (snapshotting) and mirroring a VFS. Note that mirrors and clones are read-only storage entities. Note also that the Bmap and Bmap volume modules do not have knowledge of the underlying geometry of the RAID controller 330, only free block lists that may be exported by that controller.

The NFS and CIFS servers on the N-blade 110 translate respective NFS and CIFS requests into SpinFS primitive operations contained within SpinFS packets (requests). FIG. 6 is a schematic block diagram illustrating the format of a SpinFS request 600 that illustratively includes a media access layer 602, an IP layer 604, a UDP layer 606, an RF layer 608 and a SpinFS protocol layer 610. As noted, the SpinFS protocol 610 is a file system protocol that provides operations, related to those operations contained within incoming file access packets, to access files stored on the cluster 100. Illustratively, the SpinFS protocol 610 is datagram based and, as such, involves transmission of packets or “envelopes” in a reliable manner from a source (e.g., an N-blade 110) to a destination (e.g., a D-blade 500). The RF layer 608 implements a reliable transport protocol that is adapted to process such envelopes in accordance with a connectionless protocol, such as UDP 606.

Files are accessed in the SpinFS file system 450 using a file handle. FIG. 7 is a schematic block diagram illustrating the format of a file handle 700 including a VFS ID field 702, an inode number field 704 and a unique-ifier field 706. The VFS ID field 702 contains an identifier of a VFS that is unique (global) within the entire cluster 100. The inode number field 704 contains an inode number of a particular inode within an inode file of a particular VFS. The unique-ifier field 706 contains a monotonically increasing number that uniquely identifies the file handle 700, particularly in the case where an inode number has been deleted, reused and reassigned to a new file. The unique-ifier distinguishes that reused inode number in a particular VFS from a potentially previous use of those fields.

FIG. 8 is a schematic block diagram illustrating a collection of management processes that execute as user mode applications 800 on the storage operating system 400. The management processes include a management framework process 810, a high availability manager (HA Mgr) process 820, a VFS location database 830 (VLDB) process 830 and a replicated database (RDB) process 850. The management framework 810 provides a user interface via a command line interface (CLI) and/or graphical user interface (GUI). The management framework is illustratively based on a conventional common interface model (CIM) object manager that provides the entity to which users/system administrators interact with a node 200 in order to manage the cluster 100.

The HA Mgr 820 manages all network addresses (IP addresses) of all nodes 200 on a cluster-wide basis. For example, assume a network adapter 225 having two IP addresses (IP1 and IP2) on a node fails. The HA Mgr 820 relocates those two IP addresses onto another N-blade 110 of a node within the cluster to thereby enable clients to transparently survive the failure of an adapter (interface) on an N-blade 110. The relocation (repositioning) of IP addresses within the cluster is dependent upon configuration information provided by a system administrator 29. The HA Mgr 820 is also responsible for functions such as monitoring an uninterrupted power supply (UPS) and notifying the D-blade 500 to write its data to persistent storage when a power supply issue arises within the cluster.

The VLDB 830 is a database process that tracks the locations of various storage components (e.g., a VFS) within the cluster 100 to thereby facilitate routing of requests throughout the cluster. In the illustrative embodiment, the N-blade 110 of each node has a look up table that maps the VS ID 702 of a file handle 700 to a D-blade 500 that “owns” (is running) the VFS 380 within the cluster. The VLDB 830 provides the contents of the look up table by, among other things, keeping track of the locations of the VFSs 380 within the cluster. The VLDB 830 has a remote procedure call (RPC) interface, which allows the N-blade 110 to query the VLDB 830. When encountering a VFS ID 702 that is not stored in its mapping table, the N-blade 110 sends an RPC to the VLDB 830 process. In response, the VLDB 830 returns to the N-blade 110 the appropriate mapping information, including an identifier of the D-blade 500 that owns the VFS. The N-blade 110 caches the information in its look up table and uses the D-blade 500 ID to forward the incoming request to the appropriate VFS 380.

All of these management processes have interfaces to (are closely coupled to) the replicated database (RDB) 850. The RDB 850 comprises a library that provides a persistent object store (storing of objects) pertaining to configuration information and status throughout the cluster. Notably, the RDB 850 is a shared database that is identical (has an identical image) on all nodes 200 of the cluster 100. For example, the HA Mgr 820 uses the RDB library 850 to monitor the status of the IP addresses within the cluster. At system startup, each node 200 records the status/state of its interfaces and IP addresses (those IP addresses it “owns”) into the RDB database.

Operationally, requests are issued by clients 180 and received at the network protocol stack 430 of an N-blade 110 within a node 200 of the cluster 100. The request is parsed through the network protocol stack to the appropriate NFS/CIFS server, where the specified VFS 380 (and file), along with the appropriate D-blade 500 that “owns” that VFS, are determined. The appropriate server then translates the incoming request into a SpinFS request 600 that is routed to the D-blade 500. A SpinFS is a request that a D-blade 500 can understand. The D-blade 500 receives the SpinFS request and apportions it into a part that is relevant to the requested file (for use by the inode manager 502), as well as a part that is relevant to specific access (read/write) allocation with respect to blocks on the disk (for use by the Bmap module 504). All functions and interactions between the N-blade 110 and D-blade 500 are coordinated on a cluster-wide basis through the collection of management processes and the RDB library user mode applications 800.

FIG. 9 is a schematic block diagram illustrating a distributed file system (SpinFS) arrangement 900 for processing a file access request at nodes 200 of the cluster 100. Assume a CIFS request packet specifying an operation directed to a file having a specified pathname is received at an N-blade 110 of a node 200. Specifically, the CIFS operation attempts to open a file having a pathname /a/b/c/d/Hello. The CIFS server 420 on the N-blade 110 performs a series of lookup calls on the various components of the pathname. Broadly stated, every cluster 100 has a root VFS 380 represented by the first “/” in the pathname. The N-blade 110 performs a lookup operation into the lookup table to determine the D-blade 500 “owner” of the root VFS and, if that information is not present in the lookup table, forwards a RPC request to the VLDB 830 in order to obtain that location information. Upon identifying the D1 D-blade 500 owner of the root VFS, the N-blade 110 forwards the request to D1, which then parses the various components of the pathname.

Assume that only a/b/ (e.g., directories) of the pathname are present within the root VFS. According to the SpinFS protocol, the D-blade 500 parses the pathname up to a/b/, and then returns (to the N-blade 110) the D-blade 500 ID (e.g., D2) of the subsequent (next) D-blade 500 that owns the next portion (e.g., c/) of the pathname. Assume that D3 is the D-blade 500 that owns the subsequent portion of the pathname (d/Hello). Assume further that c and d are mount point objects used to vector off to the VFS that owns file Hello. Thus, the root VFS has directories a/b/ and mount point c that points to VFS c which has (in its top level) mount point d that points to VFS d that contains file Hello. Note that each mount point may signal the need to consult the VLDB 830 to determine which D-blade 500 owns the VFS and, thus, to which D-blade 500 the request should be routed.

The N-blade 110 (N1) that receives the request initially forwards it to D-blade 500 D1, which send a response back to N1 indicating how much of the pathname it was able to parse. In addition, D1 sends the ID of D-blade D2 which can parse the next portion of the pathname. N-blade N1 then sends to D-blade D2 the pathname c/d/Hello and D2 returns to N1 an indication that it can parse up to c/, along with the D-blade 500 ID of D3 which can parse the remaining part of the pathname. N1 then sends the remaining portion of the pathname to D3 which then accesses the file Hello in VFS d. Note that the distributed file system arrangement 900 is performed in various parts of the cluster architecture including the N-blade 110, the D-blade 500, the VLDB 830 and the management frame-work 810.

The distributed SpinFS architecture includes two separate and independent voting mechanisms. The first voting mechanism involves storage pools 350 which are typically owned by one D-blade 500 but may be owned by more than one D-blade 500, although not all at the same time. For this latter case, there is the notion of an active or current owner of the storage pool, along with a plurality of standby or secondary owners of the storage pool. In addition, there may be passive secondary owners that are not “hot” standby owners, but rather cold standby owners of the storage pool. These various categories of owners are provided for purposes of failover situations to enable high availability of the cluster and its storage resources. This aspect of voting is performed by the HA SP voting module 508 within the D-blade 500. Only one D-blade 500 can be the primary active owner of a storage pool at a time, wherein ownership denotes the ability to write data to the storage pool. In essence, this voting mechanism provides a locking aspect/protocol for a shared storage resource in the cluster. This mechanism is further described in U.S. patent application Publication No. US 2003/0041287 titled “Method and System for Safely Arbitrating Disk Drive Ownership”, by M. Kazar published Feb. 27, 2003, incorporated by reference herein.

The foregoing description has been directed to particular embodiments of this invention. It will be apparent, however, that other variations and modifications may be made to the described embodiments, with the attainment of some or all of their advantages. Specifically, it should be noted that the principles of the present invention may be implemented in/with non-distributed file systems. Furthermore, while this description has been written in terms of N- and D-blades, the teachings of the present invention are equally suitable to systems where the functionality of the N- and D-blades are implemented in a single system. Alternately, the functions of the N- and D-blades may be distributed among any number of separate systems wherein each system performs one or more of the functions. Additionally, the procedures or processes may be implemented in hardware, software, embodied as a computer-readable medium having program instructions, firmware, or a combination thereof. Therefore, it is the object of the appended claims to cover all such variations and modifications as come within the true spirit and scope of the invention.

1. A method for recovering a current read-write unit of a file system comprising the steps of:
losing effective access to the current read-write unit; and
promoting a read-only unit of the file system of the current read-write unit to a read-write unit of the file system.

2. A method as described in claim 1 wherein the unit of the file system includes a VFS and including the step of selecting a candidate read-only VFS which is to be promoted into the current read-write VFS.

3. A method as described in claim 2 including the step of modifying meta-data for the candidate read-only VFS enabling client-requests to be serviced by the candidate read-only VFS once the candidate read-only VFS has been promoted to the read-write VFS.

4. A method as described in claim 3 wherein the selecting step includes the step of selecting by an administrator the candidate read-only VFS which is to be promoted into the current re-write the VFS.

5. A method as described in claim 4 wherein the selecting step includes the step of selecting the candidate VFS from a group of a spinshot or mirror of the current read-write VFS.

6. A method as described in claim 5 including the step of assigning a VFS ID of the current read-write VFS to the candidate read-only VFS.

7. A method as described in claim 6 including the step of deleting the current read-write VFS.

8. A method as described in claim 7 wherein the deleting step includes the step of deleting any record of the current read-write VFS from the VLDB.

9. A method as described in claim 8 including the step of setting the candidate read-only VFS's identity to the current read-write VFS's identity in the VLDB and on a D-blade.

10. A method as described in claim 9 wherein the setting step includes the step of changing the candidate read-only VFS's name to the current read-write VFS's name.

11. A method as described in claim 10 wherein the setting step includes the step of changing the candidate read-only VFS type to read-write.

12. A method as described in claim 11 including the step of forming a mirror chain from spinshots of the current read-write VFS.

13. A method as described in claim 12 wherein the candidate read-only VFS has a data version, and including the step of swapping with the candidate read-only VFS a VFS ID of a spin shot in the chain with a data version that is less than or equal to the data version of the candidate read-only VFS for a mirror whose data version is greater than the data version of the candidate read-only VFS.

14. A method as described in claim 13 including the step of deleting a VLDP record of a mirror spinshot selected for swapping its VFS ID that is inaccessible.

15. A method as described in claim 14 including the step of deleting a mirror from the D blade and setting the mirror data version in the VLDB if no mirror spinshot of the chain is found for swapping its VFS ID to insure a full copy is performed for a next mirror of the current read-write VFS.

16. A method as described in claim 15 including copying the current read-write VFS content to a storage pool when the current read-write VFS is initially mirrored.

17. A method as described in claim 16 including copying an incremental change, represented by a delta between the data versions of the current read-write VFS and the initial mirror, to a subsequent mirror of the current read-write VFS when the subsequent mirror is performed.

18. A method as described in claim 1 wherein the promoting step includes the step of restoring the current read-write VFS within one minute of losing effective access to the current read-write VFS.

19. A method as described in claim 1 wherein the promoting step is transparent to a client.

20. A method as described in claim 1 including the step of preserving the current read-write VFS family relationship to eliminate any possibility of corrupting data on a subsequent operation.

21. An apparatus for recovering a current read-write unit of a file system comprising:
a network element which receives client requests and makes calls responding to the client requests;
a unit of the file system location database which maintains information about units of the file system;
a disk element in which the units are disposed; and
a manager which, when effective access to the current read-write unit is lost, the manager promotes a read-only unit of the file system of the current read-write unit to a read-write unit of the file system, the manager in communication with the disk element.

22. An apparatus as described in claim 21 wherein the unit of the file system includes a VFS and the manager restores the current read-write VFS within one minute of losing effective access to the current read-write VFS.

23. An apparatus as described in claim 22 including a storage pool in the disk element in which content of a VFS is stored.

24. An apparatus as described in claim 23 wherein the information about a VFS in the VFS location database identifies the VFS by name, ID and storage pool ID.

25. An apparatus as described in claim 24 wherein the manager uses a candidate read-only VFS which is to be promoted into the current read-write VFS that has been selected by an administrator.

26. An apparatus as described in claim 25 wherein the manager uses the candidate VFS selected by the administrator from a group of a spinshot or mirror of the current read-write VFS.

27. An apparatus as described in claim 26 wherein the disk element includes a D-blade.

28. An apparatus as described in claim 27 wherein the network element includes an N-blade.
